(19) United States
(12) Patent Application Publication
(10) Pub. No.: US 2003/0204614 A1
(43) Pub. Date: Oct. 30, 2003

(54) Method and apparatus for the display and distribution of cinema grade content in real time

(75) Inventor: Mary A. Spio, Long Beach, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/425,236

(22) Filed: Apr. 29, 2003

Related U.S. Application Data
(60) Provisional application No. 60/376,087, filed on Apr. 29, 2002.
(60) Provisional application No. 60/376,105, filed on Apr. 29, 2002.
(60) Provisional application No. 60/376,244, filed on Apr. 29, 2002.
(60) Provisional application No. 60/376,254, filed on Apr. 29, 2002.
(60) Provisional application No. 60/376,214, filed on Apr. 29, 2002.
(60) Provisional application No. 60/376,382, filed on Apr. 29, 2002.
(60) Provisional application No. 60/376,239, filed on Apr. 29, 2002.

(51) Int. Cl. G06F 15/16

(52) U.S. Cl. 709/231

(57) ABSTRACT

A method and apparatus for distributing cinema grade content is disclosed. Cinema grade content data is divided into packets. Metadata is added to each of the packets where the metadata include markers for aggregating the packets to produce streaming data of the cinema grade content data at a receiver. The packets are transmitted over one or more communication links to the receiver for aggregating the packets into the streaming data and displaying the streaming data. The processes of dividing, applying metadata and transmitting are all performed in real time. The cinema grade content data need not be stored at the receiver.

### CROSS-REFERENCE TO RELATED APPLICATIONS

This application claims the benefit under 35 U.S.C. § 119(e) of the following co-pending and commonly-assigned U.S. provisional patent application, which is incorporated by reference herein:

Provisional Application Serial No. 60/376,087, filed Apr. 29, 2002, by Mary A. Spio, entitled “METHODOLOGY FOR DISPLAY AND DISTRIBUTION OF LIVE CINEMA GRADE CONTENT IN REAL TIME,” attorneys' docket number 010582.

This application is related to the following co-pending and commonly-assigned patent applications, which applications are incorporated by reference herein:

U.S. Utility patent application Ser. No. __/___,___, filed Apr. 24, 2003, by Charles F. Stirling et al., which claims the benefit of U.S. Provisional Application Serial No. 60/376,105, filed Apr. 29, 2002, by Charles F. Stirling et al., entitled “SECURE DATA CONTENT DELIVERY SYSTEM FOR MULTIMEDIA APPLICATIONS UTILIZING BANDWIDTH EFFICIENT MODULATION”, attorneys' docket number G&C 147.68-US-P1.

U.S. Utility patent application Ser. No. 10/348,454, filed Jan. 21, 2003, by Mary Spio, entitled “METHOD AND APPARATUS FOR VERY HIGH DATA RATE SATELLITE TRANSMISSION”, attorneys' docket number G&C 147.109-US-01;

U.S. Utility patent application Ser. No. __/___,___, filed on this same day herewith, by Ismael Rodriguez et al., which claims the benefit of U.S. Provisional Application Serial No. 60/376,244, filed Apr. 29, 2002, by Ismael Rodriguez et al., entitled “A METHOD TO SECURELY DISTRIBUTE LARGE DIGITAL VIDEO/DATA FILES WITH OPTIMUM SECURITY”, attorneys' docket number G&C 147.0101-US-P1;

U.S. Utility patent application Ser. No. 10/178,602, filed Jun. 24, 2002, by inventor Michael A. Enright, METHOD AND APPARATUS FOR DECOMPRESSING AND MULTIPLEXING MULTIPLE VIDEO STREAMS IN REAL-TIME, attorneys' docket number G&C 147.0080-US-U1, which claims the benefit of U.S. Provisional Patent Application Serial No. 60/376,254, filed Apr. 29, 2002, by inventor Michael A. Enright, entitled METHOD TO DECOMPRESS AND MULTIPLEX MULTIPLE VIDEO STREAMS IN REAL-TIME, attorneys' docket number G&C 147.0080-US-P1;

U.S. Utility patent application Ser. No. 10/289,043, filed Nov. 6, 2002, by inventors Andrew Strodtbeck and Susan Bach, entitled PREDISTORTED MODULATION SYSTEM FOR BANDWIDTH EFFICIENT SATELLITE LINKS, attorneys' docket number G&C 147.0089-US-U1, which claims the benefit of U.S. Provisional Patent Application Serial No. 60/376,214, filed Apr. 29, 2002, by inventors Andrew Strodtbeck and Susan Bach, entitled PREDISTORTED MODULATION SYSTEM FOR BANDWIDTH EFFICIENT SATELLITE LINKS, attorneys' docket number G&C 147.0089-US-P1;

U.S. Utility patent application Ser. No. __/___,___, filed ______, by Keith Jarett, which claims the benefit of U.S. Provisional Patent Application Serial No. 60/376,382, filed Apr. 29, 2002, by Keith Jarett, entitled HYBRID TDMA/FDM UPLINK FOR SPOT-BEAM COMMUNICATION SYSTEM, attorneys' docket number G&C 147.0092-US-P1; and

U.S. Utility patent application Ser. No. 10/___,___, filed Feb. 13, 2003, by Keith Jarrett, entitled SYSTEM AND METHOD FOR MINIMIZING INTERFERENCE IN A SPOT BEAM COMMUNICATIONS SYSTEM, attorneys' docket number G&C 147.0093-US-U1, which claims the benefit of U.S. Provisional Patent Application Serial No. 60/376,239, filed Apr. 29, 2002, by Keith Jarrett, entitled C/I MINIMIZATION FOR SPOT BEAM COMMUNICATION SYSTEM, attorneys' docket number G&C 147.0093-US-P1.

### BACKGROUND OF THE INVENTION

1. Field of the Invention

The present invention integrates satellite connectivity with existing terrestrial applications to provide a method to package, distribute and display live events with cinema grade quality on large (theater size) screen formats in real-time.

2. Description of the Related Art

In order to display live events at cinema-grade quality on theatre-size screens in real time, the content must be produced, encoded and steamed at data rates of appropriate data rates. Currently streaming video is produced and encoded for distribution over Internet at rates of up to 28.8 Kbps (modem speed of the average Internet connection) and for TV grade quality at rates below 15 Mbps. Streaming video quality is dependent in part upon the process of how it is encoded for transmission and the amount of bandwidth required for it to be viewed properly on the end user's screen. To properly display content on a theater-size screen, the proper degree of compression and packaging must be applied to the information and streamed at high speeds. Content that is streamed below a sufficient data rate appears choppy and is unusable for display on theater-sized screens at cinema grade quality.

Data objects can be transmitted from a location to another a variety of ways, including the use of the modems and public switched telephone network (PSTN), dedicated landlines, terrestrial microwave systems, and satellite systems. Satellite systems are particularly well suited for use in situations where the data is to be transmitted to multiple receivers or subscribers (e.g., “broadcasted” rather than just transmitted point to point). In recent years, it has become increasingly desirable to transmit larger and larger data objects (high resolution movies suitable for public display, for example) from one place to multiple locations in a short amount of time.

Data rates over satellites can be increased by using more powerful or wider bandwidth transponders. However, transmission bandwidth cannot be increased beyond assigned frequency bands, placing the data rates necessary to transmit cinema grade video out or reach. In addition, single transponders powerful enough to transmit cinema grade video are infeasible for technical and practical considerations (e.g. costs). Furthermore, once deployed, satellite systems cannot be easily modified to permit higher data rate transmissions.

There is a need for apparatuses and methods which transmit digital content at sufficiently high data rates to display cinema grade content in real time. There is particularly a need for such apparatuses and methods for use in a centralized digital cinema system. These and other needs are met by the present invention.

### SUMMARY OF THE INVENTION

The present invention describes a novel apparatus and method that allows content to be displayed at cinema-grade quality in real time on theater-sized screens.

The novel apparatus and method described herein allows content to be displayed at cinema-grade quality by piping a gradual and continuous data stream from a remote location directly to any large screen at a high data rate. Without this technique, files cannot be displayed on theater sized screens at cinema-grade quality in real-time; they would have to be fully downloaded to a storage location before being displayed.

Employing the present invention, content is digitized, broken into small packets of information, and communicated across the network to the content user's screen in real time. To accomplish this, markers are placed with metadata in the file for the display server to communicate information needed to properly display content. Although some buffering may be required (depending on the wealth of the content), the content data is delivered at a high enough average rate to allow a presentation of cinema grade content in real time. Throughout the specification, “real time” refers to a data communication process where the average data transmission or processing rate at steps precedent to display equals or exceeds the average data rate to the display device (e.g., a digital projector). Software is used to convert the content data files into the streaming format for transmission. Hardware and software at the user's end (e.g., an in-cinema system) is specially configured to convert the content to a streamable format, thus allowing the screen to be populated at the necessary pixel per second rate needed to display cinema grade content on a theater-sized screen.

Currently, rich content can be streamed in real time to TV screens and over the Internet to computers. This invention streams at rates more than twice current maximum data rates to allow streaming of cinema grade content to large size screens. This is possible with a combination of bandwidth efficient modulation (BEM) schemes combined with available software and hardware. See e.g., U.S. Utility patent application Ser. No. __/___,___, filed Apr. 24, 2003, by Charles F. Stirling et al., which claims the benefit of U.S. Provisional Application Serial No. 60/376,105, filed Apr. 29, 2002, by Charles F. Stirling et al., entitled “SECURE DATA CONTENT DELIVERY SYSTEM FOR MULTIMEDIA APPLICATIONS UTILIZING BANDWIDTH EFFICIENT MODULATION”, which are both incorporated by reference herein.

Because digital files must be packetized for transmission, the technique described herein provides greater control and management of the delivery process. It allows content to be smoothly displayed at high rates that are currently unachievable. It also allows synchronized display of content, and thus, the technology can be extended to other applications that require transfer of very large amounts of data in real-time. For example, in addition to feature films, live events incorporating a plurality of different sources can be presented using the invention. In addition, because the content is streamed to the displaying entities, content security is improved because there is no need for the content data to be stored in a complete file at the displaying entity.

In a typical method of the invention, cinema grade content data is divided into packets. Metadata is added to each of the packets where the metadata include markers for aggregating the packets to produce streaming data of the cinema grade content data at a receiver. The packets are transmitted over one or more communication links to the receiver for aggregating the packets into the streaming data and displaying the streaming data. The processes of dividing, applying metadata and transmitting are all performed in real time.

### BRIEF DESCRIPTION OF THE DRAWINGS

Referring now to the drawings in which like reference numbers represent corresponding parts throughout:

FIGS. 1A and 1B depict a top-level functional block diagram of one embodiment of a media program distribution system;

FIG. 2 is a functional block diagram of a computer system to perform the operations of the media preparation processor and processing system;

FIG. 3 is a block diagram of processing, transmission and display of the cinema grade content data; and

FIG. 4 is flowchart of a typical method of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

1. Overview

Currently, rich content can be streamed in real time to TV screens and over the Internet to computers. The present invention streams at rates higher than twice current maximum data rates to allow streaming of cinema grade content to large size screens in a digital cinema system. This is made possible with the combination of bandwidth efficient modulation (BEM) schemes, e.g., over satellite or fiber, combined with available software and hardware.

According to the present invention, content is digitized, broken into small packets of information, and transported sequentially across the network to the content user's screen in real time. Markers are placed with metadata in the file for the display server to communicate information needed to properly display content. Depending on the content file size, some buffering may be required. However, the content data is not stored or accumulated in a file at the user before being displayed. Rather, the content data is streamed directly to the user screen in real time.

Software is provided for converting files into the streaming format. Hardware and software at the user's end is specially configured to convert the content to a streamable format, thus allowing the screen to be populated at the necessary pixel per second rate needed to display cinema grade content on a theater-sized screen.

Because digital files have to be packetized for transmission, the method described herein provides greater control and management of the delivery process. It allows content to be smoothly displayed at rates that are currently unachievable. It also allows synchronized display of content, and thus, the technology can be extended to other applications which require the transfer of very large data files in real-time.

2. Digital Cinema System Architecture

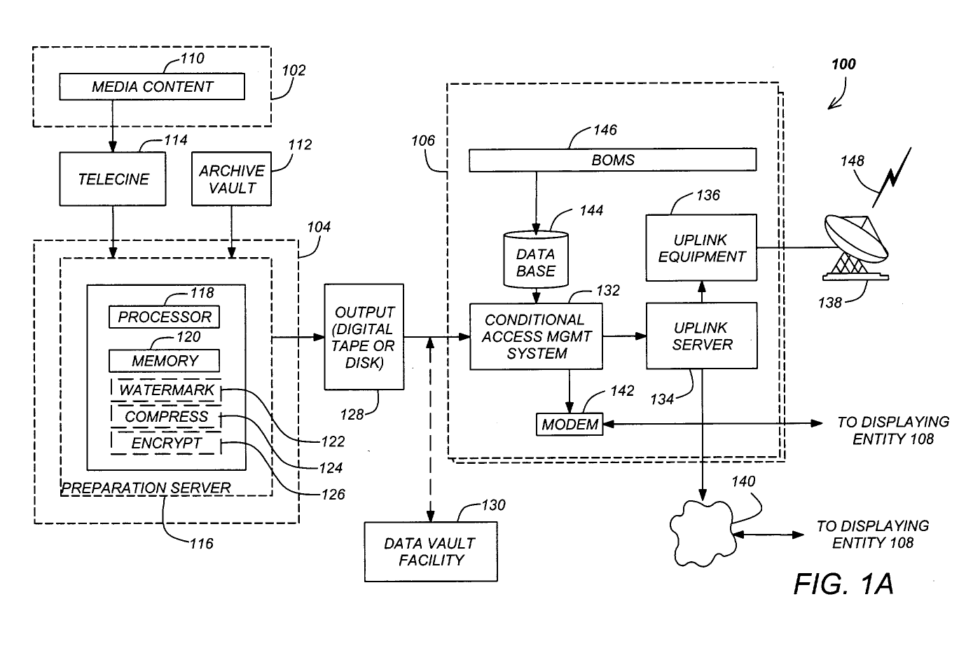

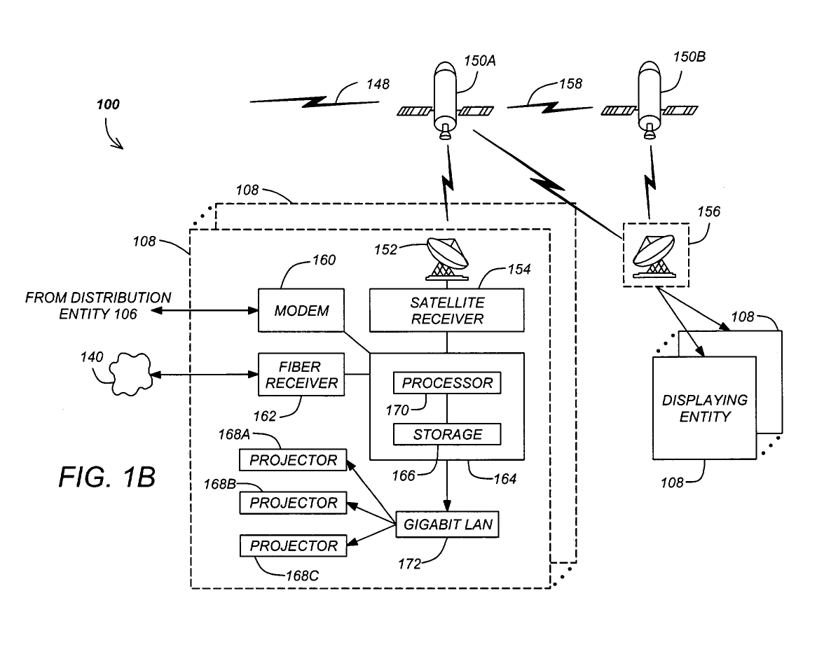

FIGS. 1A and 1B depict a top-level functional block diagram of one embodiment of a media program distribution system 100. The media distribution system 100 comprises a content provider 102, a protection entity 104, a distribution entity 106 and one or more presentation/displaying entities 108 (also referred to as an exhibitor 108). The content provider 102 provides media content 110 such as audiovisual material to the protection entity 104. The media content 110, which can be in digital or analog form, can be transmitted in electronic form via the Internet, by dedicated land line, broadcast, or by physical delivery of a physical embodiment of the media (e.g., a celluloid film strip, optical or magnetic disk/tape). Content can also be provided to the protection entity 104 (also referred to as a preparation entity) from a secure archive facility 112.

The media content 110 can be telecined by processor 114 to format the media program as desired. The telecine process can take place at the content provider 102, the protection entity 104, or a third party.

The protection entity 104 may include a media preparation processor 116. In one embodiment, the media preparation server 116 includes a computer system such as a server, having a processor 118 and a memory 120 communicatively coupled thereto. The protection entity 104 further prepares the media content 110. Such preparation may include adding protection to the media content 110 to prevent piracy of the media content 110. For example, the preparation processor 118 can add watermarking 122 and/or encrypt 126 the media content 110 to protect it. In addition, the preparation processor 118 can also apply compression 124 to the media content 110. Once prepared, the output media content 128 can be transferred to digital tape or a disk (e.g., a DVD, laserdisk, or similar medium). The output media content 128 can then be archived in a data vault facility 130 until it is needed.

When needed, the prepared output media content 128 is then provided to the distribution entity 106 (alternatively referred to hereinafter as the network operations center [NOC]). Although illustrated as separate entities, the protection entity 104 and the distribution entity 106 can be combined into a single entity, thus ameliorating some security concerns regarding the transmission of the output media content 128.

The distribution entity 106 includes a conditional access management system (CAMS) 132 (also referred to as a configuration management engine), that accepts the output media content 128, and determines whether access permissions are appropriate for the content 128. Further, CAMS 132 may be responsible for additional encrypting so that unauthorized access during transmission is prevented. Once the data is in the appropriate format and access permissions have been validated, CAMS 132 provides the output media content 128 to an uplink server 134, ultimately for transmission by uplink equipment 136 to one or more displaying entities 108 (also referred to as exhibitor systems) (shown in FIG. 1B). This is accomplished by the uplink equipment 136 and uplink antenna 138. Also, as shown, in addition or in the alternative to transmission via satellite, the media program can be provided to the displaying entity 108 via a forward channel fiber network 140. Additionally, information may be transmitted to displaying entity 108 via a modem 142 using, for example a public switched telephone network line. A land based communication such as through fiber network 140 or modem 142 is referred to as a back channel. Thus, information can be transmitted to and from the displaying entity 108 via the back channel or the satellite network. Typically, the back channel provides data communication for administration functions (e.g., billing, authorization, usage tracking, etc.), while the satellite network provides for transfer of the output media content 128 to the displaying entities 108.

The output media content 128 may be securely stored in a database 144. Data is transferred to and from the database 144 under the control and management of the business operations management system (BOMS) 146. Thus, the BOMS 146 manages the transmission of information to 108, and assures that unauthorized transmissions do not take place.

Turning to FIG. 1B, the data transmitted via uplink 148 is received in a satellite 150A, and transmitted to a downlink antenna 152, which is communicatively coupled to a satellite or downlink receiver 154.

In one embodiment, the satellite 150A also transmits the data to an alternate distribution entity 156 and/or to another satellite 150B via crosslink 158. Typically, satellite 150B services a different terrestrial region than satellite 150A, and transmits data to displaying entities 108 in other geographical locations.

As previously discussed, an essential element of the present invention is that the data rate is sufficient to allow a real time display of the output media content 128. Thus, the satellite uplink 148 (as well as any other satellite communication links, e.g., crosslinks 158) must have a data rate that equals or exceeds the rate necessary to support presentation of the output media content directly to the display systems 168 at the receiving display entities 108.

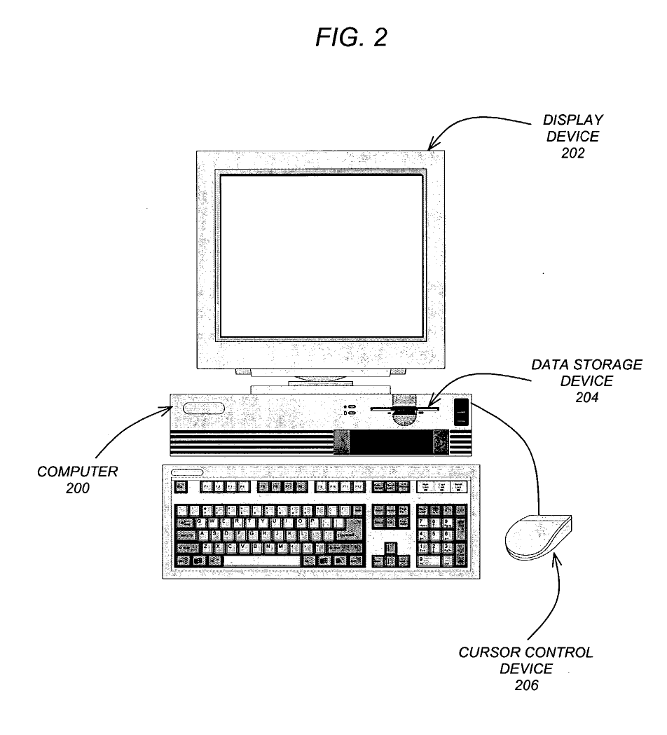

A typical displaying entity 108 comprises a modem 160 (and may also include a fiber receiver 162) for receiving and transmitting information through the back channel (i.e., via a communication path other than that provided by the satellite system described above) to and from the distribution entity 106. For example, feedback information (e.g. relating to system diagnostics, billing, usage and other administrative functions) from the exhibitor 108 can be transmitted through the back channel to the distribution entity 106. The output media content 128 and other information may be accepted into a processing system 164 (also referred to as a content server) such as a server or computer similar to that which is illustrated in FIG. 2 (see description below). The output media content 128 may then be stored in the storage device 166 for later transmission to displaying systems (e.g., digital projectors) 168A-168C. Before storage, the output media content 128 can be decrypted to remove transmission encryption (e.g. any encryption applied by the CAMS 132), leaving the encryption applied by the preparation server 116.

When the media content 110 is to be displayed, final decryption techniques are used on the output media content 128 to substantially reproduce the original media content 110 in a viewable form which is provided to one or more of the displaying systems 168A-168C. For example, encryption 126 and compression 124 applied by the preparation processor 118 is finally removed, however, any latent modification, undetectable to viewers (e.g., watermarking 122) is left intact. In one or more embodiments, a display processor 170 prevents storage of the decrypted media content 110 in any media, whether in the storage device 166 or otherwise. In addition, the media content 110 can be communicated to the displaying systems 168A-168C over an independently encrypted connection, such as on a gigabit lan 172.

FIG. 2 is a functional block diagram of a computer system 200 that can be used to perform the operations of the media preparation server 116 and processing system 164. Embodiments of the invention are typically implemented using a computer 200, which generally includes, inter alia, a display device 202, data storage devices 204, cursor control devices 206, and other devices. Those skilled in the art will recognize that any combination of the above components, or any number of different components, peripherals, and other devices, may be used with the computer 100.

Programs executing on the computer 200 (such as an operating system) are comprised of instructions which, when read and executed by the computer 200, causes the computer 200 to perform the steps necessary to implement and/or use the present invention. Computer programs and/or operating instructions may also be tangibly embodied in a memory and/or data communications devices of the computer, thereby making a computer program product or article of manufacture according to the invention. As such, the terms “article of manufacture”, “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

3. Real Time Distribution of Cinema Grade Content

The digital cinema system described above can be implemented to include hardware and software to deliver the cinema grade media content 110 to the theater-sized screens of the displaying systems 168A-168C in real time. To accomplish this, the present invention employs data streaming at very high rates. Bandwidth efficient modulation (BEM) schemes are applied to the data links (e.g., the uplink 148 between the distribution entity 106 and the displaying entities 108). Such modulation schemes enable higher data rates; a greater number of bits per symbol are transmitted than lower order modulation schemes. For example, the present invention can employ quadrature phase shift keying (QPSK) or higher order modulations to increase the number of bits per symbol. See e.g., U.S. Utility patent application Ser. No. __/___,___, filed Apr. 24, 2003, by Charles F. Stirling et al., which claims the benefit of U.S. Provisional Application Serial No. 60/376,105, filed Apr. 29, 2002, by Charles F. Stirling et al., entitled “SECURE DATA CONTENT DELIVERY SYSTEM FOR MULTIMEDIA APPLICATIONS UTILIZING BANDWIDTH EFFICIENT MODULATION”, attorneys' docket number G&C 147.68-US-P1.

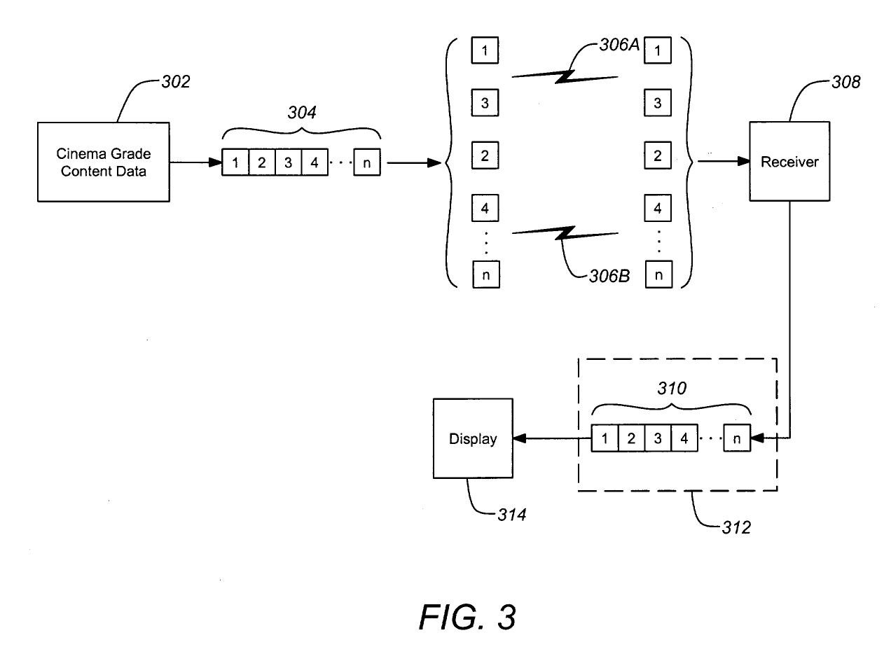

FIG. 3 is a block diagram of processing, transmission and display of the cinema grade content data 302. A typical apparatus for distributing cinema grade content includes one or more processors for dividing cinema grade content data 302 into a plurality of packets 304 and applying metadata to each of the packets 304 where the metadata include markers for aggregating the packets to produce streaming data of the cinema grade content at a receiver 308. The markers include the required sequence and multiplexing information used to aggregate the packets into the streaming data at the displaying entity 108. The cinema grade content data 302 can be from a live source (e.g., a camera feed) or from a stored source (e.g., a movie file on a hard drive or other digital storage medium). In any case, the plurality of packets 304 include all the information necessary to construct the streaming data at the displaying entity 108. Dividing the file and applying metadata can be performed by software. Thus, the processing is flexible and can be modified at a later date, e.g. to improve security and/or performance.

The packets 304 are then transmitted over one or more communication links 306A, 306B to a receiver 308 for aggregating the received packets 310 into the streaming data 312. In the media program distribution system 100 previously described, the uplink server 134 and/or uplink equipment 136 can include the one or more processors to generate the plurality of packets 304. Delivery of the cinema grade content in real time over a satellite link can be implemented by inverse multiplexing the content data over a plurality of satellite transponders to achieve an acceptable data rate; the one or more communication links can comprise one or more satellite transponder links. U.S. Utility patent application Ser. No. 10/348,454, filed Jan. 21, 2003, by Mary Spio, entitled “METHOD AND APPARATUS FOR VERY HIGH DATA RATE SATELLITE TRANSMISSION”, attorneys' docket number G&C 147.109-US-01, which is incorporated by reference herein, includes a detailed description of applicable techniques for applying metadata to the packets using identifiers as the markers to reconstruct the streaming data at the receiver. The techniques can also be applied in communicating the cinema grade content data 302 over the forward channel fiber network 140 (or the Internet) to the displaying entity 108.

In the exemplary media program distribution system 100 previously described, the receiver 308 which aggregates the received packets 310 into the streaming data 312 can be incorporated into the receiver 154 or the fiber receiver 162. The display device 314 can be a processing system 164 and displaying systems 168 as described in the displaying entity 108 of the exemplary media program distribution system 100.

An important aspect of the present invention is that processing and transmission of the cinema grade content data occurs in real time. This allows the displaying entity 108 to receive and aggregate the packets into the streaming data according to the markers of the metadata and display the streaming data of the cinema grade content in real time. In addition, aggregating of the packets in to the streaming data can be performed by software. Thus, the system is flexible and can be reconfigured if necessary to improve security and/or performance in the future. As previously, discussed the streaming data can be buffered to maintain a continuous display of the streaming data, e.g., to compensate for momentary variances in the incoming data rate. The real time transmission can also be simultaneously received by more than one receiver. Thus, the packets can be received and aggregated into the streaming data and displayed at more than one receiver.

In addition, because the cinema grade content data is processed and transmitted in real time, embodiments of the invention can be used in the distribution of live content. The cinema grade content data can originate from a plurality of sources (e.g., multiple distribution entities 106). The steps of dividing, applying metadata and transmitting are performed separately at each of the plurality of sources. At the receiver, the markers in the metadata are used to properly aggregate the packets and form the streaming data. In this case, the final data stream does not effectively exist until it is received because portions of the content are transmitted from separate sources. Synchronization in adding the appropriate metadata to the packets at the separate sources is necessary for these applications.

In a typical embodiment of the present invention, the uplink equipment 136 breaks up the output media content 128 into packets. Each packet includes metadata which describes the packets and is used to at the receiving displaying entities 108 to reconstruct the data stream of the content 128.

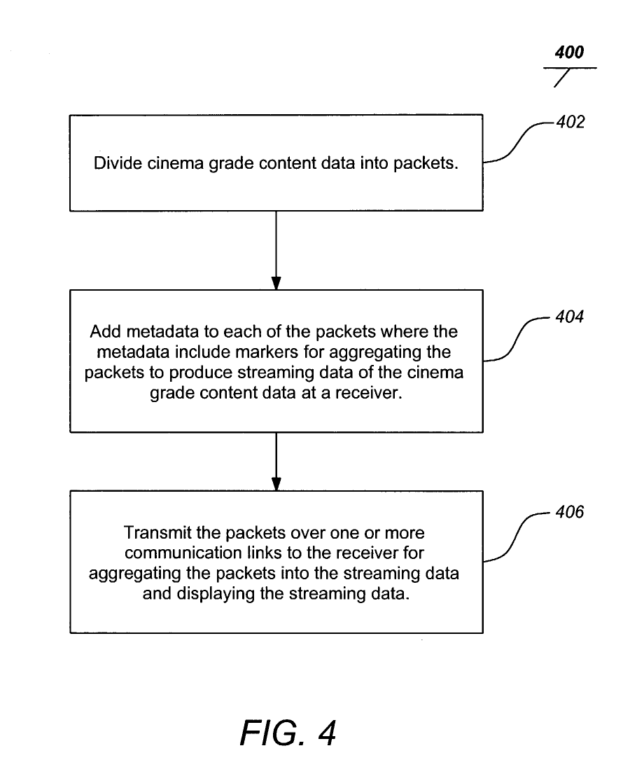

FIG. 4 is flowchart of a typical method of distributing cinema grade content in real time. The basic method 400 begins at step 402 by dividing cinema grade content data into packets. Next at step 404, metadata is added to each of the packets where the metadata include markers for aggregating the packets to produce streaming data of the cinema grade content data at a receiver. Finally, at step 406 the packets are transmitted over one or more communication links to the receiver for aggregating the packets into the streaming data and displaying the streaming data. The steps of dividing, applying metadata and transmitting are all performed in real time. This means that the average data transmission or processing rate at steps precedent to display equals or exceeds the average data rate to the display device while the instantaneous data transmission or processing rates may vary above or below the average data rate to the display device. The basic method 400 can be further modified and enhanced to include elements of the exemplary system, previously described.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for distributing cinema grade content, comprising the steps of:
dividing cinema grade content data into packets;
add metadata to each of the packets where the metadata include markers for aggregating the packets to produce streaming data of the cinema grade content data at a receiver;
transmitting the packets over one or more communication links to the receiver for aggregating the packets into the streaming data and displaying the streaming data;
wherein the steps of dividing, applying metadata and transmitting are all performed in real time.

2. The method of claim 1, wherein the one or more communication links comprise one or more satellite transponder links.

3. The method of claim 1, wherein the one or more communication links comprise an Internet connection.

4. The method of claim 1, wherein dividing the file and applying metadata are performed by software.

5. The method of claim 1, wherein the cinema grade content data originates from a plurality of sources and the steps of dividing, applying metadata and transmitting are performed separately at each of the plurality of sources.

6. The method of claim 1, wherein the markers include sequence and multiplexing information used to aggregate the packets into the streaming data.

7. The method of claim 1, wherein cinema grade content data is from a live source.

8. The method of claim 1, wherein cinema grade content data is from a stored source.

9. The method of claim 1, further comprising receiving and aggregating the packets into the streaming data according to the markers of the metadata and displaying the streaming data of the cinema grade content in real time.

10. The method of claim 9, wherein the packets are received and aggregated into the streaming data and displayed at more than one receiver.

11. The method of claim 9, wherein aggregating the packets into the streaming data is performed by software.

12. The method of claim 9, wherein the streaming data is buffered to maintain a continuous display of the streaming data.

13. An apparatus for distributing cinema grade content, comprising:
one or more processors for dividing cinema grade content data into packets and applying metadata to each of the packets where the metadata include markers for aggregating the packets to produce streaming data of the cinema grade content at a receiver; and
a transmitter for transmitting the packets over one or more communication links to the receiver for aggregating the packets into the streaming data and displaying the streaming data;
wherein the cinema grade content data is processed and transmitted in real time.

14. The apparatus of claim 13, wherein the one or more communication links comprise one or more satellite transponder links.

15. The apparatus of claim 13, wherein the one or more communication links comprise an Internet connection.

16. The apparatus of claim 13, wherein dividing the file and applying metadata are performed by software.

17. The apparatus of claim 13, wherein the cinema grade content data originates from a plurality of sources and dividing, applying metadata and transmitting are performed separately at each of the plurality of sources.

18. The apparatus of claim 13, wherein the markers include sequence and multiplexing information used to aggregate the packets into the streaming data.

19. The apparatus of claim 13, wherein cinema grade content data is from a live source.

20. The apparatus of claim 13, wherein cinema grade content data is from a stored source.

21. The apparatus of claim 13, further comprising receiving and aggregating the packets into the streaming data according to the markers of the metadata and displaying the streaming data of the cinema grade content in real time on a display device.

22. The apparatus of claim 21, wherein the packets are received and aggregated into the streaming data and displayed at more than one receiver.

23. The apparatus of claim 21, wherein aggregating the packets into the streaming data is performed by software.

24. The apparatus of claim 21, wherein the streaming data is buffered to maintain a continuous display of the streaming data.
